(19) United States
(12) Patent Application Publication
(10) Pub. No.: US 2012/0235632 A9
(43) Pub. Date: Sep. 20, 2012

(54) INTRA-ORAL CHARGING SYSTEMS AND METHODS

(75) Inventors: Reza KASSAYAN, Atherton, CA (US); John SPIRIDIGLIOZZI, San Mateo, CA (US); Amir ABOLFATHI, Woodside, CA (US)

(73) Assignee: SONITUS MEDICAL, INC., San Mateo, CA (US)

(21) Appl. No.: 12/365,676

(22) Filed: Feb. 4, 2009

Related U.S. Application Data
(63) Continuation-in-part of application No. 11/841,477, filed on Aug. 20, 2007.

(51) Int. Cl. H02J 7/00

(52) U.S. Cl. 320/108

(57) ABSTRACT

Systems and methods are disclosed for charging an intra-oral apparatus includes an intra-oral appliance having an appliance charger coil defining a first portion of an electromagnetic loop; and a charger base having a base charger coil defining a second portion of the electromagnetic loop, wherein the appliance charger coil and the base charger coil in combination transfer energy for inductive charging.

### BACKGROUND OF THE INVENTION

Due to the convenience of use and safety through sealed power electronics, induction charging has been used in portable motorized toothbrushes that typically contain a rechargeable battery which is charged by induction. Induction charging systems provide the benefit of recharging the battery of a device without a wired connection. Other portable wireless communication devices, such as two-way RF radios, cellular phones, paging devices, and wireless communicators, commonly utilize a rechargeable battery that, in certain applications, is recharged by contactless induction charging.

U.S. Pat. No. 6,917,182 discloses an inductive charging system with an inductive charger having an inductive charging surface and an alignment feature depicted on a surface of the inductive charger indicating a location of the inductive charging surface. A structural feature may extend substantially perpendicular to the alignment feature and provides a guide for positioning of a portable device to facilitate inductive changing of the portable device by the inductive charging surface. The inductive charger may include a plurality of inductive chargers. The plurality of inductive chargers may include a field of inductive chargers positioned to facilitate charging of a portable device by two or more of the plurality of the inductive chargers.

Alternatively, devices have been charged by connecting the terminals of a battery to a charging cable. This can be done directly if the charging source provides regulated power. For sources that provide unregulated power, a power regulator may be needed to provide clean power to the battery. However, when the appliance operates in an intra-oral environment which contains saliva, the charging of the battery can be challenging.

### SUMMARY OF THE INVENTION

In one aspect, systems and methods are disclosed for charging an intra-oral apparatus includes an intra-oral appliance having an appliance charger coil defining a first portion of an electromagnetic loop; and a charger base having a base charger coil defining a second portion of the electromagnetic loop, wherein the appliance charger coil and the base charger coil in combination transfer energy for inductive charging.

In another aspect, systems and methods are disclosed for charging a portable appliance having an appliance charger coil with open ends defining a fraction of an electromagnetic loop using a charger base having a base charger coil with open ends defining the rest of the electromagnetic loop. The appliance charger coil and the base charger coil in combination complete an electromagnetic circuit for inductive charging.

In another aspect, the system charges an auditory appliance having a semi-circular appliance charger coil through a base station having a semi-circular base charger coil. This is done by placing the semi-circular appliance charger coil next to the semi-circular base charger coil to form a circular shaped combination and to complete an electromagnetic circuit; and applying energy to the semi-circular base charger coil to inductively transfer energy to the semi-circular appliance charger coil.

In yet another aspect, an apparatus includes a portable appliance having an appliance charger coil; and a charger base having a base charger coil with an open end to receive the appliance charger coil portion, wherein the appliance charger coil and the base charger coil in combination complete an electromagnetic flux for inductive charging.

In another aspect, an intra-oral appliance includes a cylindrical appliance charger coil. A charger base having a rod-like base charger coil adapted to project through the cylindrical appliance charger coil. When mated for recharging purposes, the intra-oral appliance charger coil and the base charger coil in combination complete an electromagnetic flux for inductive charging. The intra-oral appliance can be a bone-conduction transducer as discussed in more details below.

Correspondingly, in yet another aspect, the system can provide the intra-oral appliance with a rod-shaped appliance charger coil; and a charger base having a cylindrical base charger coil adapted to receive the rod-shaped appliance charger coil. When the intra-oral appliance charger coil and the base charger coil mate, they complete an electromagnetic flux for inductive charging.

Implementations of the above aspect may include one or more of the following. A charger circuit can receive energy from the appliance coil. The charger circuit can include a regulator circuit connected to a charging circuit. An energy storage device such as a battery or a super-capacitor can be connected to the charger circuit. A voltage regulator can be connected to the energy storage device to supply power to the portable appliance. The appliance can be a behind the ear (BTE) housing. A microphone can extend from the BTE housing. One or more intra-oral appliances each having an intra-oral appliance charger coil can be used in conjunction with the BTE microphone. The charger base can have one or more intra-oral appliance charger coils, each adapted to engage the intra-oral appliance charger coil to charge one intra-oral appliance. The intra-oral appliance can be a bone-conduction transducer for relaying sound and multimedia information to the user.

In yet another embodiment, a direct charge apparatus includes an intra-oral appliance having an appliance charger port accessible while under liquid immersion; an energy storage device coupled to the appliance charger port and adapted to be recharged while under liquid immersion; and a charger base having a base charger coil adapted to electrically couple to the appliance charger port to recharge the energy storage device.

Implementations of the direct recharge embodiment can include one or more of the following. The energy storage device can be a battery or a supercapacitor. The liquid can be saliva or water. The intra-oral appliance can be a waterproof chamber that receives the recharging coils so that recharging can be done without liquid contacting the terminals. This can be done with a twist lock cap in one embodiment. In another embodiment, the energy storage device has first and second terminals, comprising a unidirectional electrical device to prevent shorting of the first and second terminals when exposed to the liquid. The unidirectional electrical device can be a transistor or a diode or any suitable electric flow control valve.

Advantages of the preferred embodiments may include one or more of the following. The charging system is easy to operate—users only need to drop the device being charged into its receptacle to complete the inductive current loop and initiate the charging operation, or apply a charger head that maintains contact with the oral appliance by the use of a magnet. The coil can be made to be small, enabling a space efficient form-factor that is important for miniature appliances such as those that are worn inside the mouth. The charging system provides precise control of input voltage and regulation in the base of the charging system. The charging system can efficiently charge multiple devices at a time while maintaining charge efficiency. The system matches the charging energy to the energy storage devices for optimum efficiency and minimizing wasted energy. The system minimizes wasted energy would be transformed into heat, which can be harmful to battery cells, operation of the charging device, or operation of the battery operated device. The system provides a relatively inexpensive induction charging system which provides the capability of simultaneously, and efficiently, charging multiple devices. The battery charger houses an internal battery that will continue to charge the external devices while traveling or should the unit lose power.

### BRIEF DESCRIPTION OF THE DRAWINGS

FIG. 1 shows an exemplary inductive charging system for a behind the ear (BTE) device.

FIG. 2 shows an exemplary circuit to charge a battery which can then power a portable appliance such as the BTE device.

FIGS. 3A-3B show various perspective views of components in the BTE external microphone.

FIG. 4 shows an exemplary charger base to recharge the portable appliance.

FIG. 5 shows an inductive charger for an oral appliance.

FIG. 6 shows the oral appliance adapted to be inductively charged by the charger of FIG. 5.

FIGS. 7A-7D show various exemplary alternative charging configurations.

FIG. 7E-7G show exemplary embodiments for direct recharging.

FIG. 8 shows one exemplary appliance that receives inductive charging.

FIG. 9 shows an exemplary bone conduction hearing system.

FIG. 10 shows one exemplary block diagram of a BTE audio appliance and an intra-oral transducer appliance.

### DETAILED DESCRIPTION OF THE INVENTION

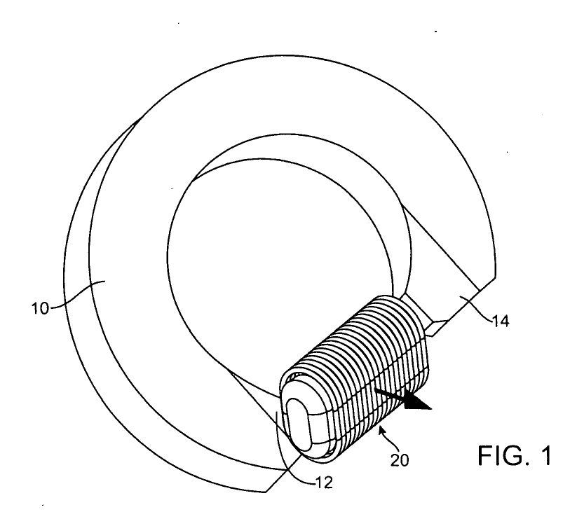

One embodiment of the present invention is a battery charging system for use with an induction charger to charge a portable appliance such as an intraoral appliance, a head-set, or a behind the ear (BTE) external microphone. As shown in FIG. 1, the battery charging system includes a first coil portion 10 located on a charger base and a second coil portion 20 located on the appliance, such as the BTE device. When the user needs to recharge the battery in the appliance, the user places the second coil portion 20 between two ends 12 and 14 of the first coil portion 10 to complete the magnetic flux loop. The completion of the loop in turn induces current flow on the second coil portion. The current flow is then regulated and used to charge an energy storage device such as a battery or a super-capacitor, among others. Notably, the battery charging system can charge a number of devices. Accordingly, a plurality of such devices can be simultaneously, and efficiently, charged using a single induction charger.

The system of FIG. 1 provides a charger base having a base charger coil 10 with an open end defined by ends 12-14 to receive the appliance charger coil portion 20. When an energy storage device such as a battery needs to be recharged, the appliance charger coil portion 20 is placed on the open end of the charger base so that the appliance charger coil 20 and the base charger coil 10 in combination complete an electromagnetic flux for inductive charging.

The first coil portion 10 and the second coil portion 20 can include a plurality of turns of wire. As defined herein, a turn is a single wind or convolution of a conductor or semi-conductor. Notably, a voltage induced in the second coil 20 due to the magnetic field generated by the first coil 10 is proportional to the level of magnetic flux flowing through the wire turns in the first and second coils 10 and 20. The coil 10 and 20 can include a conductive and/or semi-conductive material to facilitate a flow of electric current through the secondary coil 20. Further, the first coil 10 can be operatively connected to receive time-varying electric current from a power supply (not shown). For example, the electric current can be sinusoidal alternating current (A/C), pulsed current, or any other electric signal which causes the coils 10 and 20 to generate a time-varying magnetic field. In one arrangement, the power supply can be configured to mate with an AC electrical outlet.

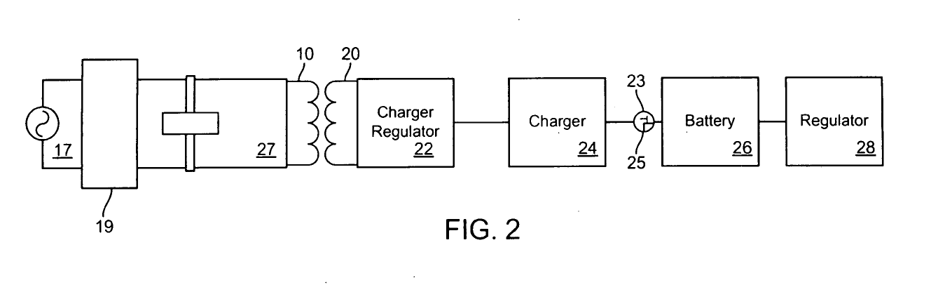

Referring to FIG. 2, a block diagram of a system to inductively charge a portable appliance is shown. AC line input 17 is used to provide power to a plug 19. The AC supply may be filtered by a capacitor 27 to provide a stable AC input voltage regardless of droop or other line problems. The voltage is provided to the first coil portion 10. The first coil portion 10 can be electromagnetically coupled to the second coil portion 20 of a battery charging system for a portable appliance.

In this system, the coil portion 20 picks up electromagnetic energy emanating from the charger base station. The energy is in the form of electrical current which is provided to a charger regulator 22. The charger regulator boosts the voltage and smoothes out variations in the received energy using one or more filters. One or more filters can be used to remove electrical noise. The regulated DC output is provided to a charger 24 which converts the energy into a suitable form for charging a energy storage device such as a super-capacitor or a battery, among others. The charger 24 can be optimized for different battery technology. For example, NiCad batteries require a certain set charging characteristics, and Lithium Ion batteries require another set charging characteristics. The charger 24 customizes the energy provided by the charger regulator 22 for the specific chemistry or requirements of the battery to optimize the battery charging operation. The connection between the charger 24 and the battery 26 can be separated after charging to minimize size and/or weight of the portable appliance. The energy from the battery 26 is provided to a second regulator 28 that provides the voltage needed by the electronics in the appliance.

The battery charging system can be used to charge the energy storage device 26, for example a battery cell. In one arrangement, the battery charging system can reside within a battery operated device and provide electrical outputs 23, 25 to supply energy to the energy storage device 26, for example via electrical contacts. The electrical contacts or connectors 23, 25 allow the energy storage device 26 and subsequent regulator 28 to separate from the charger circuitry after the energy storage device 26 has been fully charged. In an alternate arrangement, the battery charging system (including the energy storage device 26) can reside within the housing of the entire device. In either case, the energy storage device 26 can be a battery which is detachable from the battery operated device. For example, the battery can be made from any rechargeable cell technology including, but not limited to, nickel-cadmium, nickel-metal hydride, and lithium ion technologies. In another arrangement, the cell can be a capacitor. The energy storage device 26 can be detachable from, or fixed to, the battery operated device.

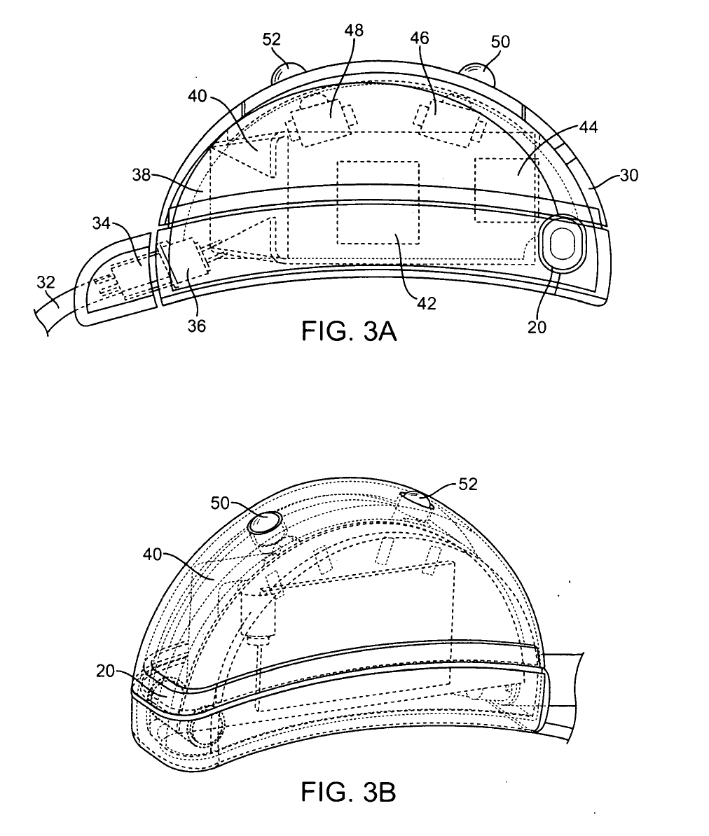

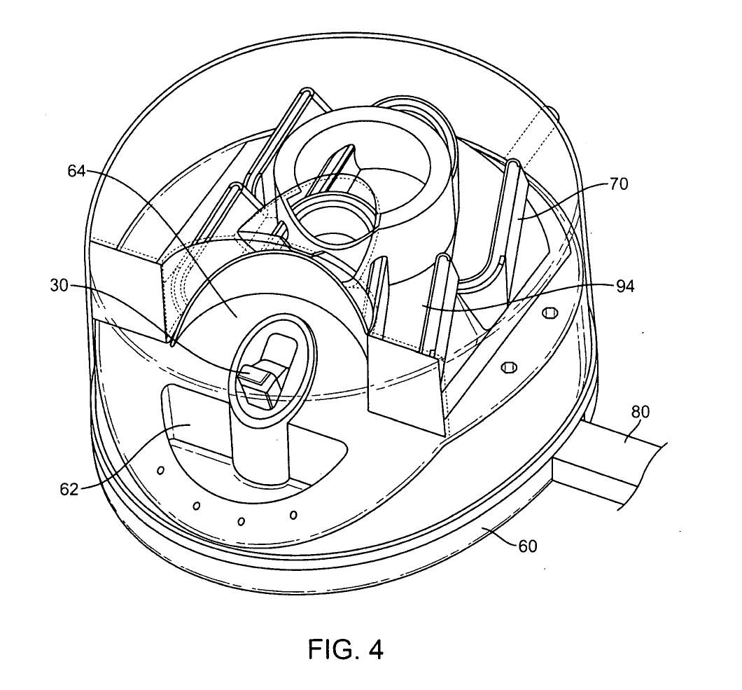

FIGS. 3A-3B show various perspective X-ray views of an exemplary BTE external microphone 30. In FIG. 3A, a microphone input 32 is provided to a connector 34 which mates with a second connector 36 in the BTE external microphone. The microphone input is provided to electronics on a printed circuit board (PCB) 38 which contains a number of devices such as ICs 42-44 as well as switches 46-48 which are used as volume + and volume − switches. Resilient buttons 50 and 52 receive user volume input and in turn translate the user volume input into switch actuations for switches 46-48. The PCD 38 is also connected to the BTE charging coil 20. The energy captured by the charging coil 20 is used to charge a battery 40.

FIG. 3B shows a perspective rear view of the BTE external microphone 30 of FIG. 3A. The BTE external microphone is recharged when the BTE coil or second coil portion 20 is placed between the ends of the first coil portion in the charger base.

FIG. 4 shows an exemplary charger base 60. The base contains a microphone recess 62 which can receive various sized microphones. The base 60 has an oval region 64 which is adapted to receive the BTE external microphone 30 of FIGS. 3A-3B. Once docked, the BTE external microphone 30 receives energy through its second coil portion 20 and the energy is used to charge the battery 26 inside the BTE external microphone 30. FIG. 4 does not show the charger coil, which is under the cover and located near the BTE hearing device creating the inductive charging circuit.

The base 60 can be provided in any arrangement compatible for use in an induction charging system. For example, the base 60 can be a low profile cylindrical stand, as shown. The base also can be configured as a stand, a box, a bowl, a tub, a substantially planar pad, or any other suitable shape. In yet another arrangement, the base can be provided with contours configured to receive specific battery operated devices.

In one arrangement, the oval region 64 can be a dielectric material (e.g. rubber or plastic) and the first coil portion 10 can be embedded within the dielectric material. Other base arrangements can be used. For instance, the first coil 10 can be disposed above or below the base 60. Further, the base 60 can be other types of material. For example, the base can have one or more regions having ferromagnetic or paramagnetic materials disposed within the base to enhance or contour a magnetic field generated by the coils 10 and 20.

In operation, one or more battery operated appliances or devices can be proximately located to the base 60. For example, the battery operated BTE external microphone 30 can be seated on the base 60 at the oval region 64. Additionally, one or more oral appliances can be positioned on the oral appliance holder 70 and be recharged at the same time. The battery operated appliances/devices also can be positioned over, under, or near the base 30 such that the magnetic field generated by the coils 10 and 20 couples to the devices. The base also receives energy through a power connector 80. The connector 80 can be connected to an AC line, or to a suitable DC source such as a car battery, for example. In one embodiment, the power can be derived from a computer bus such as power from a USB port.

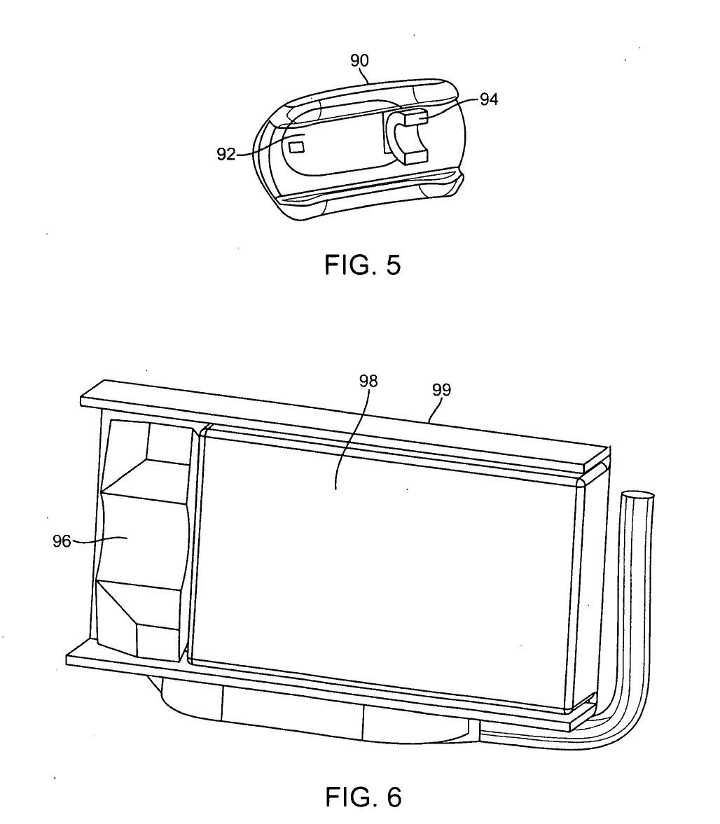

FIG. 5 shows an inductive charger head 90 for one of the battery operated appliance, in this case an intra-oral appliance 99 as discussed in more details below. FIG. 6 shows the oral appliance 99 adapted to be inductively charged by the charger of FIG. 5.

Turning now to FIG. 5, a charger head 90 includes a PCB 92 with charging electronics that receive power from a charger coil 94 and a magnet embedded in the charger head 90. The magnet in the charger head 90 of FIG. 5 in turn is attracted to the coil 96 of FIG. 6.

Referring now to FIG. 6, an appliance 99 includes an appliance coil 96 that engages the charger coil 94 to complete the electromagnetic flux to deliver energy to charge a battery 98 in the oral appliance 99.

The system of FIG. 1 provides a charger base having a base charger coil with an open end to receive the appliance charger coil portion. When the battery needs to be recharged, the appliance charger coil portion is placed on the open end of the charger base so that the appliance charger coil and the base charger coil in combination complete an electromagnetic flux for inductive charging.

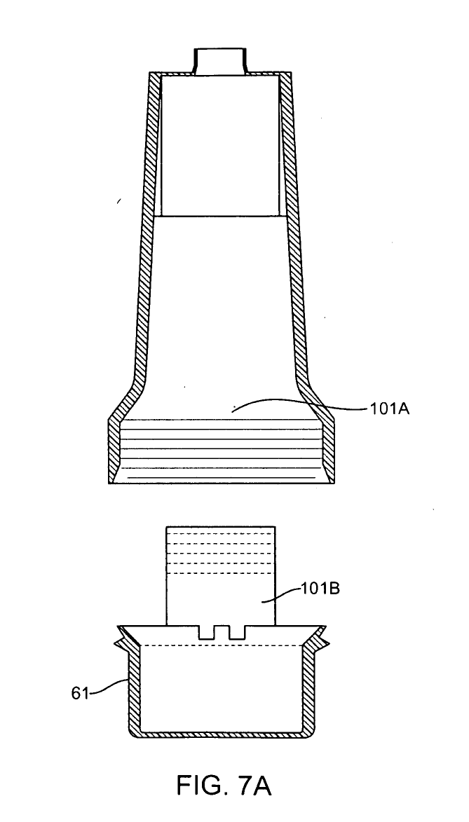

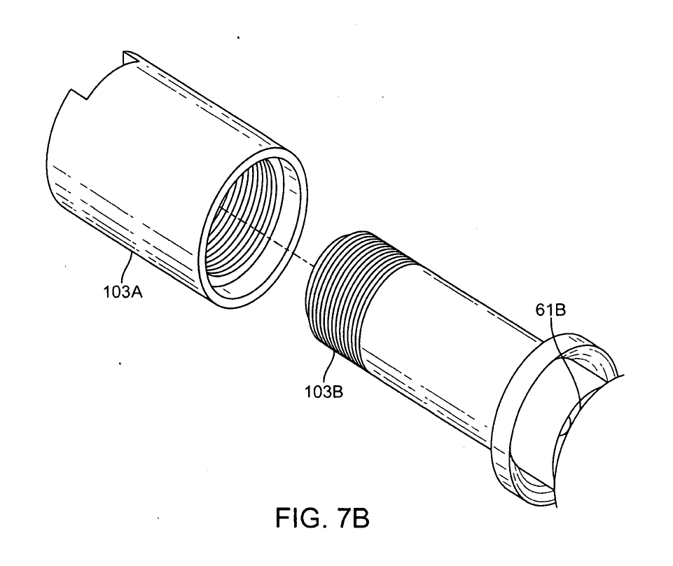

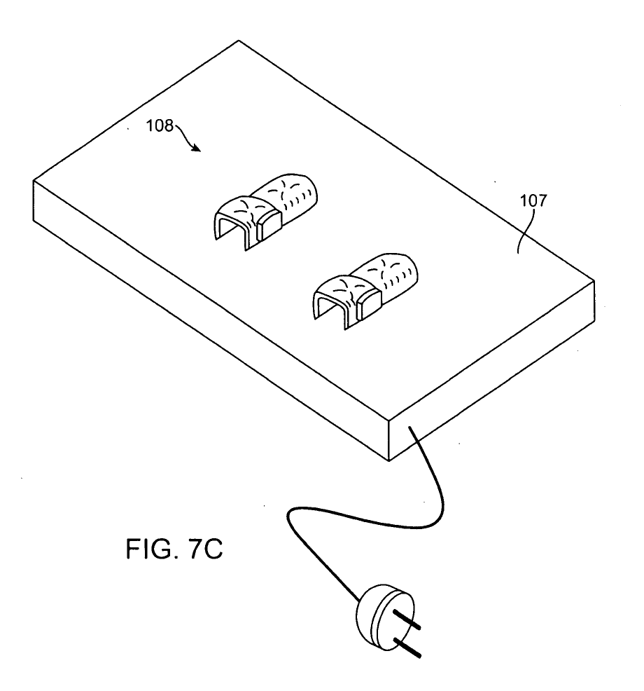

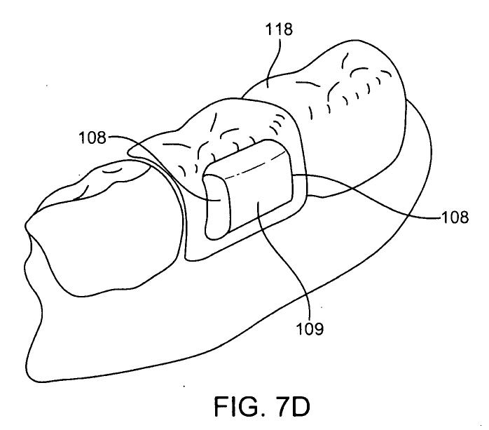

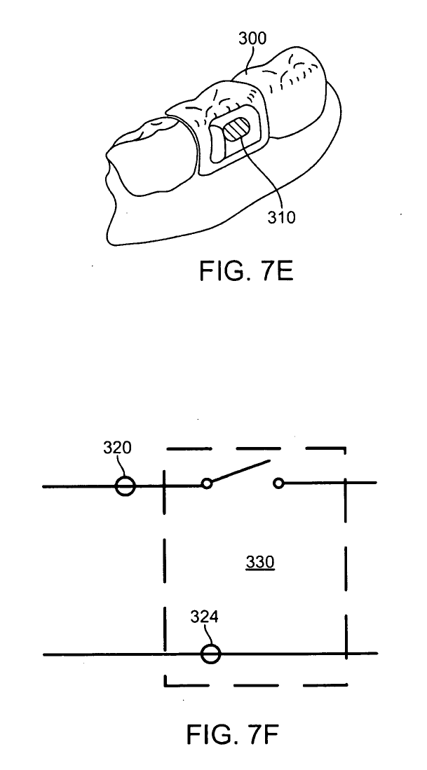

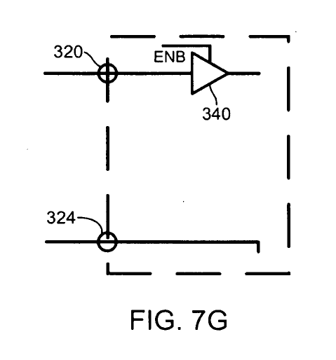

FIGS. 7A-7D show various exemplary alternative charging configurations. FIG. 7A shows a base station 61 with base station charging coils 101B that is adapted to electromagnetically engage coils 101A on the appliance. The appliance embodiment of FIG. 7A can be screwed onto the base 61A during recharging operation. In FIG. 7B, a base station 61B contains charging coils 103B that is adapted to electromagnetically engage coils 103A on the appliance. In the embodiment of FIG. 7B, during recharging operations, the cylindrical appliance coils 103A can be slipped over a rod or projection where the base station charger coils 103B are wound. FIG. 7C shows a tablet charging arrangement where the base station coils are positioned under a flat base or table 107 while appliances 108 can be placed on top of the table 107. FIG. 7D shows yet another charging configuration where a charging wire 109 is threaded or inserted through an opening in an intra-oral appliance 109 mounted on one or more teeth 118. The charging wire or coil 109 is effectively an elongated rod that cooperates with the corresponding receiving coil in the appliance 109 to charge a suitable energy storage device contained in the appliance 109. This embodiment performs in-situ recharging without requiring removal of the appliance 109 for recharging or battery replacement purposes.

The device of FIG. 7A or 7B can work with an intra-oral appliance having a cylindrical appliance charger coil; and a charger base having a base charger coil adapted to project through the cylindrical appliance charger coil, wherein the intra-oral appliance charger coil and the base charger coil in combination complete an electromagnetic flux for inductive charging. The intra-oral appliance can be a bone-conduction transducer as discussed in more details below.

Correspondingly, the system can provide the intra-oral appliance having a rod-shaped appliance charger coil; and a charger base having a cylindrical base charger coil adapted to receive the rod-shaped appliance charger coil, wherein the intra-oral appliance charger coil and the base charger coil in combination complete an electromagnetic flux for inductive charging.

FIG. 7E-7G show exemplary embodiments for direct charging. In the embodiment of FIG. 7E, a direct charge apparatus includes an intra-oral appliance mounted on one or more teeth 300. The appliance has an appliance charger port 310 accessible while under liquid immersion. The appliance includes an energy storage device connected to the appliance charger port 310. The port 310 has suitable liquid protection so that the electric cable terminals are not shorted while immersed. The liquid protection can be physical, such as a rubber sealant that allows the wire to touch the terminals but keep the liquid out. The liquid protection can be O-rings, for example, or can simply be rubber cover made of a highly compressed material that keeps water out while a rigid rod such as a conductive needle is inserted through the compressed material. Such O-rings or rubber covers to allow a needle to puncture through the O-rings or rubber covers to have sealed access to electrical terminals to recharge the energy storage device. In this manner, the battery is adapted to be recharged while under liquid immersion. A charger base is external and has a base charger coil adapted to electrically connect to the appliance charger port to recharge the energy storage device. In one implementation, the energy storage device can be a battery or a supercapacitor and can be immersed in a liquid such as saliva in the user's mouth or water in an appliance cleaning chamber.

The intra-oral appliance can include a waterproof chamber covering port 310 that receives the recharging coils so that recharging can be done without liquid contacting the terminals. This can be done with a twist lock cap in one embodiment. In one embodiment, the port 310 can contain waterproof septums that provide access to the battery terminals. In another embodiment, the energy storage device has first and second terminals 320 and 324. A unidirectional electrical device 330 can be connected across the terminals 320-324 to prevent shorting of the first and second terminals when exposed to the liquid. In FIG. 7F, the unidirectional electrical device 330 can be an electromechanical relay, a solid state relay, a transistor or a diode or any suitable electric flow control valve. The device 330 passively controls current flow without significant energy loss. In FIG. 7G, a device 340 such as active transistor is controlled through input ENB to connect the power line 320 during charging operation and to disconnect line 320 during operation to prevent shorting problem. The device 340 can be a relay, or can be a solid state relay that is normally not connected to minimize power consumption.

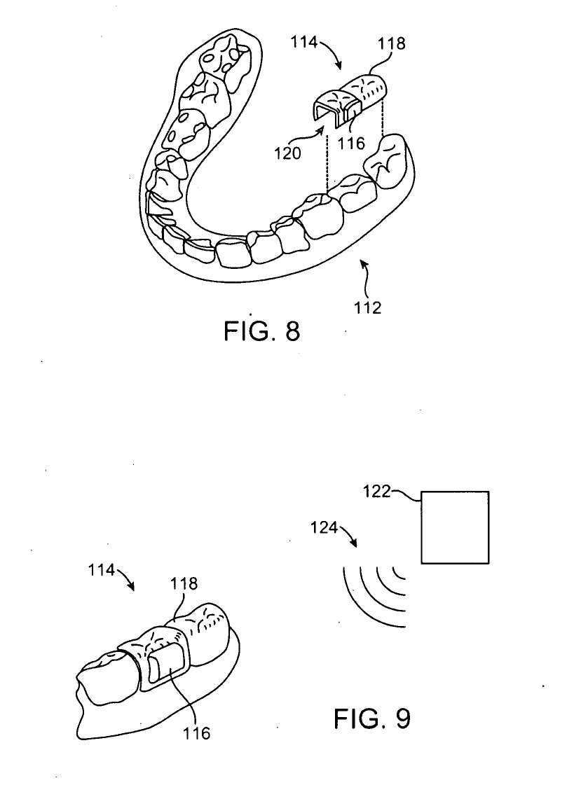

FIG. 8 shows one exemplary appliance that is powered by the inductive charging system of FIGS. 1-6. The perspective view of FIG. 8 shows the patient's lower dentition illustrating the hearing aid assembly 114 comprising a removable oral appliance 118 and the electronics and/or transducer assembly 116 positioned along a side surface of the assembly 114. In this variation, oral appliance 118 may be fitted upon two molars 112 within tooth engaging channel 120 defined by oral appliance 118 for stability upon the patient's teeth, although in other variations, a single molar or tooth may be utilized. Alternatively, more than two molars may be utilized for the oral appliance 118 to be attached upon or over. Moreover, electronics and/or transducer assembly 116 is shown positioned upon a side surface of oral appliance 118 such that the assembly 116 is aligned along a buccal surface of the tooth 112; however, other surfaces such as the lingual surface of the tooth 112 and other positions may also be utilized. The figures are illustrative of variations and are not intended to be limiting; accordingly, other configurations and shapes for oral appliance 18 are intended to be included herein.

Another variation of a removable oral appliance places an appliance over an entire row of teeth in the manner of a mouthguard. In this variation, appliance may be configured to cover an entire bottom row of teeth or alternatively an entire upper row of teeth. In additional variations, rather than covering the entire rows of teeth, a majority of the row of teeth may be instead be covered by appliance. In yet other variations, an arch can be used to cover a portion of the palate of the user. However, other variations may be configured to have an arch which covers the entire palate of the user.

Generally, the volume of electronics and/or transducer assembly 116 may be minimized so as to be unobtrusive and as comfortable to the user when placed in the mouth. Although the size may be varied, a volume of assembly 116 may be less than 800 cubic millimeters. This volume is, of course, illustrative and not limiting as size and volume of assembly 116 and may be varied accordingly between different users.

In one variation, with assembly 114 positioned upon the teeth, as shown in FIG. 9, an extra-buccal transmitter assembly 122 located outside the patient's mouth may be utilized to receive auditory signals for processing and transmission via a wireless signal 124 to the electronics and/or transducer assembly 116 positioned within the patient's mouth, which may then process and transmit the processed auditory signals via vibratory conductance to the underlying tooth and consequently to the patient's inner ear.

The transmitter assembly 122, as described in further detail below, may contain a microphone assembly as well as a transmitter assembly and may be configured in any number of shapes and forms worn by the user, such as a watch, necklace, lapel, phone, belt-mounted device, etc.

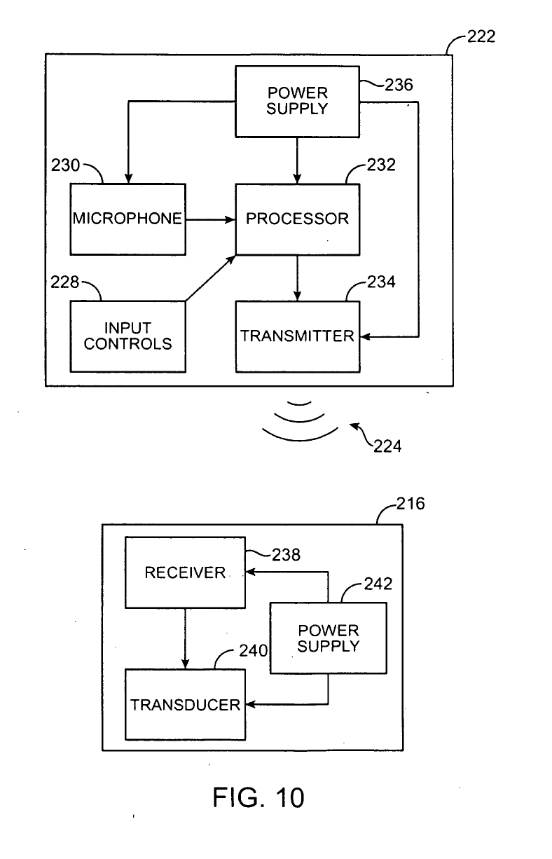

FIG. 10 shows one exemplary block diagram of a BTE audio appliance 222 and an intra-oral transducer appliance 216. In this variation of hearing aid assembly, an extra-buccal transmitter assembly 222 can include a microphone 230 for receiving sounds and which is electrically connected to processor 232 for processing the auditory signals. Processor 232 may be connected electrically to transmitter 234 for transmitting the processed signals to the electronics and/or transducer assembly 216 disposed upon or adjacent to the user's teeth. The microphone 230 and processor 232 may be configured to detect and process auditory signals in any practicable range, but may be configured in one variation to detect auditory signals ranging from, e.g., 250 Hertz to 20,000 Hertz.

With respect to microphone 230, a variety of various microphone systems may be utilized. For instance, microphone 230 may be a digital, analog, and/or directional type microphone. Such various types of microphones may be interchangeably configured to be utilized with the assembly, if so desired.

Power supply 236 may be connected to each of the components in transmitter assembly 222 to provide power thereto. The transmitter signals 224 may be in any wireless form utilizing, e.g., radio frequency, ultrasound, microwave, Blue Tooth® (BLUETOOTH SIG, INC., Bellevue, Wash.), etc. for transmission to assembly 16. Assembly 22 may also optionally include one or more input controls 28 that a user may manipulate to adjust various acoustic parameters of the electronics and/or transducer assembly 16, such as acoustic focusing, volume control, filtration, muting, frequency optimization, sound adjustments, and tone adjustments, etc.

The signals transmitted 224 by transmitter 234 may be received by electronics and/or transducer assembly 216 via receiver 238, which may be connected to an internal processor for additional processing of the received signals. The received signals may be communicated to transducer 240, which may vibrate correspondingly against a surface of the tooth to conduct the vibratory signals through the tooth and bone and subsequently to the middle ear to facilitate hearing of the user. Transducer 240 may be configured as any number of different vibratory mechanisms. For instance, in one variation, transducer 240 may be an electromagnetically actuated transducer. In other variations, transducer 240 may be in the form of a piezoelectric crystal having a range of vibratory frequencies, e.g., between 250 to 4000 kHz.

Power supply 242 may also be included with assembly 216 to provide power to the receiver, transducer, and/or processor, if also included. Although power supply 242 may be a simple battery, replaceable or permanent, other variations may include a power supply 242 which is charged by inductance via an external charger as discussed above. Additionally, power supply 242 may alternatively be charged via direct coupling to an alternating current (AC) or direct current (DC) source. Other variations may include a power supply 242 which is charged via a mechanical mechanism, such as an internal pendulum or slidable electrical inductance charger as known in the art, which is actuated via, e.g., motions of the jaw and/or movement for translating the mechanical motion into stored electrical energy for charging power supply 242.

In another variation of assembly 216, rather than utilizing an extra-buccal transmitter, BTE external microphone assembly may be configured as an independent assembly contained entirely within the user's mouth. Accordingly, the assembly may include an internal microphone in communication with an on-board processor. The internal microphone may have any number of different types of microphones, as described above. The processor may be used to process any received auditory signals for filtering and/or amplifying the signals and transmitting them to the transducer, which is in vibratory contact against the tooth surface. The inductively charged power supply, as described above, may also be included within the assembly for providing power to each of the components of the assembly as necessary.

An electronic and transducer device may be attached, adhered, or otherwise embedded into or upon a removable dental or oral appliance to form a hearing aid assembly. Such a removable oral appliance may be a custom-made device fabricated from a thermal forming process utilizing a replicate model of a dental structure obtained by conventional dental impression methods. The electronic and transducer assembly may receive incoming sounds either directly or through a receiver to process and amplify the signals and transmit the processed sounds via a vibrating transducer element coupled to a tooth or other bone structure, such as the maxillary, mandibular, or palatine bone structure. Alternatively and/or additionally, the vibrating transducer element may transmit the processed sounds via other routes such as underlying cartilage tissue or other implantable structures.

The assembly for transmitting vibrations via at least one tooth may generally comprise a housing having a shape which is conformable to at least a portion of the at least one tooth, and an actuatable transducer disposed within or upon the housing and in vibratory communication with a surface of the at least one tooth.

The removable oral appliance 118 may be fabricated from various polymeric or a combination of polymeric and metallic materials using any variety of methods. For instance, in one variation of fabricating an oral appliance, a three-dimensional digital scanner may be used to image the dentition of the patient, particularly the tooth or teeth upon or about which the oral appliance is to be positioned. The scanned image may be processed via a computer to create a three-dimensional virtual or digital model of the tooth or teeth.

Various three-dimensional scanning modalities may be utilized to create the three-dimensional digital model. For instance, intra-oral cameras or scanners using, e.g., laser, white light, ultrasound, mechanical three-dimensional touch scanners, magnetic resonance imaging (MRI), computed tomography (CT), other optical methods, etc., may be utilized. Once the three-dimensional image has been captured, the image may then be manipulated via conventional software to create a direct three-dimensional print of the model. Alternatively, the image may be used to directly machine the model. Systems such as computer numerical control (CNC) systems or three-dimensional printing processes, e.g., stereolithography apparatus (SLA), selective laser sintering (SLS), and/or other similar processes utilizing three-dimensional geometry of the patient's dentition may be utilized. In another alternative, a mold may be generated from the print to then allow for thermal forming of the appliance directly upon the created mold. And yet in other variations, the three-dimensional image may be used to create an injection mold for creating the appliance. Once the scanned image has been processed to create a three-dimensional virtual or digital model of the tooth or teeth, the housing for the electronics/transducer assembly may be digitally imposed or created in the digital model. Alternatively, a physical model of the housing may be positioned upon the appropriate tooth or teeth TH and the dentition with the housing may be scanned to create the digital model. In either case, the resulting digital model may be utilized to create a three-dimensional virtual or digital model of the appliance having the housing integrated therewith. The digital model of the appliance may then be used to print or create the physical oral appliance. Accordingly, an oral appliance which conforms to the patient's dentition may be formed to ensure secure contact upon or against the dentition while maintaining comfort to the user.

In another alternative method, once the three-dimensional model of the appliance has been created, the oral appliance may be machined directly, e.g., utilizing computer numerical control machining, from polymeric materials to create the appliance.

The oral appliance may have an electronic and/or transducer assembly for receiving incoming sounds and transmitting processed sounds via a vibrating transducer element coupled to a tooth or teeth. The oral appliance may be formed or fabricated via three-dimensional digital scanning systems or via impression molding to create a housing for the electronics and/or transducer assembly as well as to securely conform the appliance to the user's dentition.

In fabricating or manufacturing such an oral appliance, the appliance may generally conform closely to the patient's dentition such that intimate contact between the transducer and the surface of the at least one tooth is securely maintained. Despite the secure contact, patient comfort is ideally maintained as well. Accordingly, one method for fabricating the oral appliance may generally comprise scanning at least the portion of the dentition such that a corresponding three-dimensional image is created, manipulating the image such that the housing for the electronics and/or transducer assembly is positioned along a side surface of the dentition, and forming the oral appliance having the housing portion from the image whereby the oral appliance is conformable to the portion of dentition.

Another method for fabricating the oral appliance may generally comprise adhering the housing along the side surface of the portion of dentition, scanning at least the portion of the dentition having the housing such that a corresponding three-dimensional image is created, and forming the oral appliance having the housing portion from the image whereby the oral appliance is conformable to the portion of dentition.

Yet another method for fabricating the oral appliance may generally comprise providing a dental tray sized to cover at least the portion of the patient's dentition, wherein the dental tray defines the housing, filling a channel defined along the dental tray with a settable polymer, placing at least the portion of the patient's dentition within the channel such that the polymer conforms to a shape of the dentition until the polymer hardens, and removing the dental tray from the hardened polymer.

The oral appliance can be used in a variety of applications, including hearing aid applications. The appliance can also be used in general sound transmission for medical and communication applications such as treating tinnitus, treating stuttering problem. The appliance can communicate through cellular and Bluetooth to provide one-way or two-way communications, among others. The appliance can also be used to store personally identifiable medical information for certain military or medical identification purposes.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

What is claimed is:

1. An apparatus, comprising:
a. an intra-oral appliance having an appliance charger coil defining a first portion of an electromagnetic loop; and
b. a charger base having a base charger coil defining a second portion of the electromagnetic loop, wherein the appliance charger coil and the base charger coil in combination transfer energy for inductive charging.

2. The apparatus of claim 1, comprising a charger circuit coupled to the appliance coil portion.

3. The apparatus of claim 2, wherein the charger circuit comprises a regulator circuit coupled to a charging circuit.

4. The apparatus of claim 2, comprising an energy storage device coupled to the charger circuit.

5. The apparatus of claim 4, comprising a voltage regulator coupled to the energy storage device to supply power to the portable appliance.

6. The apparatus of claim 1, wherein the appliance comprises a behind the ear (BTE) external microphone housing.

7. The apparatus of claim 6, comprising a microphone coupled to the BTE external microphone housing.

8. The apparatus of claim 1, comprising one or more intra-oral appliances each having an intra-oral appliance charger coil.

9. The apparatus of claim 8, wherein the charger base comprises one or more intra-oral appliance charger coils, each adapted to engage the intra-oral appliance charger coil to charge one intra-oral appliance.

10. The apparatus of claim 8, wherein the intra-oral appliance comprises a bone-conduction transducer.

11. A method for charging an auditory appliance having a semi-circular appliance charger coil with a base station having a semi-circular base charger coil, comprising:
a. placing the semi-circular appliance charger coil next to the semi-circular base charger coil to form a loop; and
b. applying energy to the semi-circular base charger coil to inductively transfer energy to the semi-circular appliance charger coil.

12. The method of claim 11, comprising regulating energy to be delivered to the semi-circular base charger coil.

13. The method of claim 11, comprising storing energy in an energy storage device.

14. The method of claim 13, comprising regulating energy from the energy storage device and supplying regulated power to the hearing appliance.

15. The method of claim 11, wherein the auditory appliance comprises a behind the ear (BTE) external microphone housing.

16. The method of claim 11, comprising capturing sound using a microphone.

17. The method of claim 11, comprising receiving sound signal at one or more intra-oral appliances, each having an intra-oral appliance charger coil.

18. The method of claim 17, comprising delivering sound to a user through a bone-conduction transducer.

19. An apparatus, comprising:
a. an intra-oral appliance having a cylindrical appliance charger coil; and
b. a charger base having a base charger coil adapted to project through the cylindrical appliance charger coil, wherein the intra-oral appliance charger coil and the base charger coil in combination complete an electromagnetic flux for inductive charging.

20. The apparatus of claim 19, wherein the intra-oral appliance comprises a bone-conduction transducer.

21. An apparatus, comprising:
a. an intra-oral appliance having a rod-shaped appliance charger coil; and
b. a charger base having a cylindrical base charger coil adapted to receive the rod-shaped appliance charger coil, wherein the intra-oral appliance charger coil and the base charger coil in combination complete an electromagnetic flux for inductive charging.

22. The apparatus of claim 21, wherein the intra-oral appliance comprises a bone-conduction transducer.

23. An apparatus, comprising:
a. an intra-oral appliance having an appliance charger port accessible while under liquid immersion;
b. an energy storage device coupled to the appliance charger port and adapted to be recharged while under liquid immersion; and
c. a charger base having a base charger coil adapted to electrically couple to the appliance charger port to recharge the energy storage device.

24. The apparatus of claim 23, wherein the energy storage device comprises a battery or a supercapacitor.

25. The apparatus of claim 23, wherein the liquid comprises saliva or water.

26. The apparatus of claim 23, wherein the energy storage device has first and second terminals, comprising a unidirectional electrical device to prevent shorting of the first and second terminals when exposed to the liquid.

27. The apparatus of claim 26, wherein the unidirectional electrical device comprises a transistor or a diode.

28. The apparatus of claim 23, wherein the charger port comprises a twist lock door to allow access to electrical terminals to recharge the energy storage device.

29. The apparatus of claim 23, wherein the charger port comprises waterproof septums coupled to electrical terminals to recharge the energy storage device.

30. The apparatus of claim 23, wherein the charger port comprises O-rings or rubber covers to allow sealed access to electrical terminals to recharge the energy storage device.
